(19) United States
(12) Patent Application Publication
(10) Pub. No.: US 2023/0021955 A1
(43) Pub. Date: Jan. 26, 2023

(54) ENERGY-EFFICIENT CONTROL OF A DEVICE FOR CONTINUOUSLY CONVEYING MATERIAL

(71) Applicants: thyssenkrupp Industrial Solutions AG, Essen (DE); thyssenkrupp AG, Essen (DE)

(72) Inventor: Viktor RAAZ, Bochum (DE)

(73) Assignees: thyssenkrupp Industrial Solutions AG, Essen (DE); thyssenkrupp AG, Essen (DE)

(21) Appl. No.: 17/786,755

(22) PCT Filed: Dec. 10, 2020
(86) PCT No.: PCT/EP2020/085400

§ 371 Date: Jun. 17, 2022

(30) Foreign Application Priority Data
Dec. 20, 2019 (DE) 10 2019 220 430.9

(51) Int. Cl. B65G 43/08

(52) U.S. Cl. CPC B65G 43/08; B65G 2203/0241; B65G 2203/0258

(57) ABSTRACT

A control system for a device for continuously conveying material is provided for at least one conveyor belt device adapted for continuously conveying the material and having at least one conveyor belt. The conveyor belt device can be operated by one or more drives in working processes to provide a predeterminable setpoint conveyor flow. The control system is configured to register at least one value of a power and/or energy consumed by at least one of the drives during a working process and to determine an energy efficiency for the respective working process and for the predetermined setpoint conveyor flow with the aid of the at least one value of the consumed power and/or energy. The control system also configured to provide control data relating to drive speed for the at least one drive as a function of the energy efficiency.

### TECHNICAL FIELD

The present document relates to embodiments of a control system for a device for continuously conveying material. The document furthermore relates to embodiments of a method for controlling a device for continuously conveying material.

### BACKGROUND

Devices for continuously conveying material are used worldwide, for example in the excavation of materials or the conveying of bulk materials (slag, ores, fuels, construction materials) over long distances, for example in opencast mining. In many applications, the conveyor flow to be managed is very large, for example in the range of several metric tons per hour. The conveyor sections are also relatively long, for example several kilometers. The energy expenditure for the drive energy of the devices is correspondingly high. Such devices for continuously conveying material usually comprise at least one conveyor belt and will also be referred to below as conveyor belt systems, or belt conveyor systems. In a continuously working conveyor belt, the material to be conveyed is regularly transported by a continuously operated drive (for example a drive engaging on a deflection roller of the conveyor belt). This is usually done with a predefined drive speed (operating state with a constant conveyor speed). In this case, an individual working process of such a device is regularly also characterized by a substantially homogeneous drive movement. Alternatively, start/stop processes are required, or at least optionally provided for bridging long time windows.

Not least because of the large masses moved and the concomitant inertias, switching or regulation of the conveyor belt systems has hitherto conventionally been disregarded in practice. In particular, the start-up processes may require a relatively large amount of time and energy, and possibly also cannot be chronologically planned in a particularly straightforward way in accordance with upstream and/or downstream system components.

Conveyor belt devices may also be constructed from a plurality of partial sections. When considering a conveyor belt system as a whole, on the one hand different working processes (or transport processes) may then be referred to in relation to the partial sections, and on the other hand in the course of time a plurality of chronologically successive and/or positionally sequenced working processes (for example starting up, normal operating state, shutting down) may also be referred to in relation to an individual partial section.

Detailed control of conveyor belt systems, possibly also adaptable to an instantaneous situation, in respect of optimizable operating parameters is, however, to date rather unusual. Not least because of parameters varying along a respective partial section (for example troughing of the belt, curves or gradients along the section guiding, number and relative spacing of support rollers), it has hitherto not seemed particularly practical to be able to specify a particular way of control or regulation. To date, it has therefore also been necessary to tolerate a relatively high energy demand even when the conveyor belt system is not actually operating fully loaded (for example no material feed, little load).

EP 3 173 879 A1 discloses a method for controlling a conveyor belt.

It is an object of the present invention to improve the control of a device for continuously conveying material with the use of at least one conveyor belt, particularly also in respect of energy optimization of working processes.

### DESCRIPTION

In order to achieve the above object, a control system for a device for continuously conveying material as claimed in claim 1 is proposed, the device comprising at least one conveyor belt device adapted for continuously conveying the material and having at least one conveyor belt, wherein the conveyor belt device can be operated by means of one or more drives in a plurality of working processes in order to provide a predeterminable setpoint conveyor flow.

Accordingly, the control system is configured and intended, in particular for a plurality of (chronologically successive and/or positionally sequenced) working processes, to register at least one value of a power (in particular electrical power) and/or energy consumed by at least one of the drives during a working process (in particular overall), and to determine an energy efficiency for the respective working process and for the predetermined setpoint conveyor flow and/or for an instantaneous actual conveyor flow with the aid of the at least one value of the consumed power and/or energy, the control system furthermore being configured to provide control data relating to the drive speed, in particular control data for a frequency converter (frequency-referenced control), for the at least one drive as a function of the (respective) energy efficiency. The control system may for this purpose be connected or connectable to the device in order to exchange data. Such a configuration of the control system also allows in particular adaptive energy-efficient speed regulation, in particular permanently with continuously applied optimization measures. Preferably, optimization of the speed is carried out as a function of running resistances, in particular iteratively as far as an optimum at which the ratio of speed to running resistance is particularly advantageous (in particular high). Advantageously, the step size of an optimization algorithm is in this case adapted or used as a continuously variable step width (especially avoiding a local optimum). In particular, a non-proportional dependency between speed and running resistance may also energetically be taken into account. Optionally, the control system takes into account an amount of material fed to the conveyor belt (in particular with a time dependency) and/or the control system specifies a lower threshold value for a conveyor belt speed. This can also minimize the risk of the conveyor belt being overloaded.

The conveyor belt device furthermore has at least one occupancy sensor. The control system is configured to determine the length-referenced belt occupancy by integrating the conveyor belt speed with respect to time. The occupancy of the conveyor belt is thus registered at a point, and the load is therefore known position-dependently from the chronological sequence and the known movements, in particular the time-dependent speed of the conveyor belt. The control system is configured to determine the cleaned total running power from the total drive power minus the material lifting power. For this purpose, the height profile of the conveyor belt is known to the control system. The respective potential energy of the load can therefore be determined from the height profile of the conveyor belt and the length-referenced load. The lifting work performed is given by the variation thereof.

A height profile in the scope of the invention is intended to mean knowledge of the position and the sequence of the conveyor belt and all other constituents of the device, specifically in respect of the height position of the material being conveyed.

For optimized frequency control, a test run may be carried out, for example running up the conveyor belt under no load to a standard or maximum speed. By the test run, the frequency control can be adapted to an instantaneous status of the system, in particular also as a function of the ambient temperature.

The control system makes it possible, for example, to determine an optimal standby speed for an empty (unloaded) or loaded conveyor belt, particularly as a function of the operating temperatures of the drives, of the ambient temperature, of the response times (drive-specific ramps) when switching the drives (varying the drive power).

In the procedure described here, one or more occupancy sensors or flow monitors may be implemented. An occupancy sensor according to the invention (filling-level or throughput sensor) can make it easier to register the actual instantaneous conveyor belt occupancy along the conveyor belt section (determining the instantaneous throughput rate or conveyor rate), in particular also at the entry of the system. Dividing this throughput value by the instantaneous belt speed delivers a corresponding length-referenced belt occupancy (for example [kg/m] or [m³/m]), in particular also at the entry transfer point (x=0) while taking into account falling times and redistribution times in respect of the material/bulk material. By integrating the conveyor belt speed with respect to time, according to the invention the length-referenced belt occupancy at the respectively determined time can be correlated with a length-specific conveyor belt coordinate. Advantageously, regulation is carried out in such a way that the desired conveyor belt occupancy is complied with as a target variable, in particular as a constant target variable (minimizing the variation of the belt occupancy). In this case, conveyor flow information may be provided in advance with a time buffer in the range of a few seconds, for example 5 to 10 s; this also allows adaptation according to energy-optimized ramps (in particular with torque limitation) for the switchover of drives. Particularly in the case of very lengthy conveyor belts, this leads to energy advantages and long-lasting use of the components.

By correlation of the length-referenced belt mass occupancy over the entire belt system, not only can the total material mass instantaneously being conveyed on the conveyor belt or conveyor belts be determined, but also according to the invention a material lifting power may be subtracted from the total drive power and a “cleaned” total running power may therefore be determined. The material lifting power is given by the height profile and therefore by the height variation of the load of the belt system. The instantaneous lifting power may in this case be determined as a sum-product of the work due to gravity (product of the material mass and “g”-acceleration of gravity) and the lifting speed (product of the instantaneous belt speed and the sine of the section inclination or section gradient in %) for a respective section segment.

The energy efficiency evaluation may be carried out on the one hand with reference to the moved mass, and on the other hand in particular also as a function of an instantaneous momentum of the moved material masses. In this regard, a reference to the mass according to the present disclosure may also include a reference to a momentum. The ratio of the “cleaned” total running power (kW) to the momentum of the moved material masses (with or without taking into account the conveyor-belt and support-roller masses) also allows quantitative evaluation of the energy efficiency for pure horizontal transport. The physical unit resulting in this case [kWh/(t·km)] or respectively [J/(kg·m)] or [N/kg] is comparable to the specific total transport resistance, and is to be related either only to the transported material mass or to the total mass and the total transport section.

The momentum of the moved material mass means in particular the sum-product of the moved material masses times the movement speed. The ratio of these two quantities (drive power to momentum, or vice versa) relative to one another facilitates the quantitative evaluation of an energy efficiency, in particular also for horizontal transport).

Optionally, the control quality may be further improved by establishing a periodicity (timespan) for the control or by establishing a dependency of events (for example full belt emptying).

The energy efficiency may also initially be determined individually in respect of each of the drives. Usually, a plurality of drives are interconnected with one another. The control data are preferably provided as a function of all drives involved.

The maximum and/or required conveyor performance of the device may, for example, be achieved with different settings of parameters and speeds. It has been found that the total drive power needed in this case, in particular the energy demand of the drives for a completed working process, may vary significantly with the settings even for an equal conveyor performance. For a particular conveyor situation, an optimal setting or regulation which corresponds to a minimum energy demand may therefore be found. The value or the characterization of this optimal operating state may depend in particular on the material properties, the load, the section sequence, or also on the temperature and/or moisture. Mutual dependencies between these quantities are generally complex and make accurate prediction difficult. The proposed control system therefore registers actual values of the energy consumption and thus determines an actual energy efficiency. With the aid of this energy efficiency that has been determined, it is possible to select particularly energy-saving settings and to convey a predetermined amount of material in an energy-saving fashion. Since the energy used has a direct effect on the wear of the device, in particular of the conveyor belt and the drives, not only may the energy consumption be reduced, but it is furthermore possible to reduce the wear of the device. In this way, for example, maintenance intervals may also be increased.

The conveyor belt may, for example, have a troughed cross-sectional profile. The conveyor belt may, however, also be arranged in the shape of a tube or droplet at least on partial segments of the conveyor section. The respective conveyor belt may be mounted hanging or supported. The device is, for example, a conveyor belt system which comprises at least one conveyor belt device.

According to one embodiment, the ratio of the consumed energy of the drives within a working process to a/the setpoint conveyor flow and/or to an instantaneous conveyor flow of the working process, in particular the total consumed energy of the operated drives (in particular integration over all the drive powers), is calculated in order to determine the energy efficiency. The instantaneous conveyor flow is, for example, a conveyor flow which deviates by a certain percentage from a setpoint conveyor flow desired in terms of material flow technology and/or in terms of energy. This ratio has, for example, the unit J/m³ or J/t or respectively kWh/m³ or kWh/t.

According to one embodiment, the control system is configured to provide the device with control data in relation to a subsequent working process as a function of the energy efficiency determined for the at least one working process (in particular for a plurality of working processes). The control system may, for example, determine particularly energy-saving parameter values and cause the device to carry out a working process or a plurality of working processes with the energy-saving parameter values. The control system in turn determines the energy efficiency in these working processes as well. The control system may therefore provide regulation which regulates one or more settings of the device to values that are as energy-efficient as possible.

The control system may furthermore be configured to receive sensor data (in particular from the device) and calculate the control data as a function of the sensor data. The sensor data may for example comprise a power consumed by a drive or a plurality of drives of the device, a material mass taken up by means of the (respective) conveyor belt (conveyor flow information), a material volume taken up by means of the conveyor belt, environmental data, measurement values in respect of a section sequence (geometry or geological features of the environment) or terrain geometry. The real section guiding may in this case also differ from previously established or determined section guiding. The control system may be configured adaptively and, for example, determine an instantaneous occupancy and load of the conveyor belts in respect of a real section sequence or in respect of an interconnection of a plurality of conveyor belts which is selected in an individual case, and readjust the drives. As an alternative, adaptive regulation is possible by means of measuring a volume flow of the material. For example, the drive speed is regulated as a function of an instantaneously measured volume flow. By means of the sensor data, it is possible to configure the control system as adaptive regulation. Optionally, the control system itself comprises the corresponding sensors.

Optionally, the control system is configured to determine an energy efficiency coefficient in order to determine the energy efficiency. The energy efficiency coefficient is, for example, equal to the value of the consumed energy (expressed in joules or in kilowatt-hours; in particular the total consumed energy of the drives within a working process) of the device divided by a total volume (expressed for example in cubic meters) or a total mass (expressed for example in metric tons) of material, in particular of the material conveyed during the working process. The lower the energy efficiency coefficient, the higher the efficiency. The energy efficiency coefficient has for example the unit J/m³, J/t, kWh/m³ or kWh/t. The energy efficiency coefficient also facilitates continuous (permanent) energy efficiency evaluation. The energy efficiency coefficient may also be specified as a minimization target (target variable) in a parameter study or a real parameter variation, particularly with a speed variation in a predetermined variation range.

According to one refinement, the consumed drive power of at least one drive of the device, in particular of all the aforementioned drives, optionally of all drives of the device, is used in order to determine the energy efficiency coefficient. The conveyor belt can be moved by means of the conveyor belt drive. The conveyor belt drive is, for example, a drive engaging on a deflecting drum of the conveyor belt device. By means of the conveyor belt drive, a conveyor belt is usually set in a revolving movement in order to transport away the material taken up.

According to one embodiment, the control system is furthermore configured to determine at least one optimized variation parameter, by which the energy efficiency is increased in comparison with other values of the variation parameter, that is to say the energy efficiency coefficient is minimized, by varying at least one variation parameter over a plurality of working processes. The actual efficiency may therefore be determined and successively improved during ongoing operation of the device.

Each working process successively comprises, for example, at least approximately constant conveyor movement by at least one of the drives and at least one accelerating and/or decelerating drive actuation by at least one of the drives. Optionally, the at least one variation parameter comprises or describes a value (for example an instantaneous speed or a setpoint speed angle, an instantaneous acceleration or a setpoint acceleration) or a function (for example a speed sequence or acceleration sequence) of at least one conveyor movement. As an alternative or in addition, the at least one variation parameter comprises or describes a value (for example a time, energy consumption) or a function (for example an energy consumption sequence) of at least one drive actuation.

According to one embodiment, the control data are based on an optimized value of the conveyor movement and an optimized speed or an optimized speed sequence of the drive actuation (adaptation of a drive movement). Optionally, the control system is configured to calculate the optimized speed (or a time window therefor) of the drive actuation from the product of a predetermined speed of the drive actuation times the ratio of a predetermined value of the conveyor movement to the modified value of the conveyor movement. The drive actuation is therefore varied inversely proportionally to the value of the conveyor movement during the optimization.

The at least one variation parameter may be or comprise a predeterminable maximum conveyor rate (maximum setpoint conveyor flow). This is beneficial in particular when it has been found in many operating situations that the maximum conveyor rate achievable with the device is to be maintained only for a relatively small proportion of the time. If, for example, a fixed time period is available for conveying a predefined amount of material and if this time period would not be fully used with the maximum achievable conveyor rate, the conveyor rate may be used as a variation parameter, in particular by reducing the setpoint conveyor rate.

Optionally, the control system comprises a user interface for adjusting at least one variation parameter. For example, the user interface makes it possible to select a variation parameter from a multiplicity of parameters. The user interface comprises, for example, a display device and/or an input means.

According to one embodiment, the control system is configured to provide control data, which cause a plurality of drives of the device to carry out a plurality of working processes according to a predefined variation, over a plurality of working processes.

According to one refinement, the variation parameter is a value varied according to the predefined variation, for example the range of a speed change (minimum or maximum variation; preferred value change range). In this way, particularly efficient control may be achieved, and/or the control may also be adapted to features of the drives used or to the size of the masses to be moved.

Optionally, the control system is configured to determine the total energy efficiency of a plurality of, in particular (chronologically and/or positionally) successive, working processes (of one, a plurality or all of the drives of the device). The efficiency of a group of working processes may thus be determined.

According to one aspect, a device for continuously conveying material is provided. The device comprises at least one conveyor belt device adapted for continuously conveying the material and having at least one conveyor belt, the conveyor belt device being operatable by means of one or more drives in a plurality of working processes in order to provide a predeterminable setpoint conveyor flow with variable drive speeds. The device furthermore comprises a control system according to any configuration described herein.

The device is optionally configured as a conveyor belt system, in particular comprising a plurality of conveyor belt devices.

According to one aspect, a method for controlling a device for continuously conveying material, comprising at least one conveyor belt device adapted for continuously conveying the material and having at least one conveyor belt, is provided, wherein the conveyor belt device can be operated by means of one or more drives in a plurality of working processes in order to provide a predeterminable setpoint conveyor flow. In order to carry out the method, in particular a control system according to any configuration described herein may be used. The method comprises the step of registering at least one value of a power (in particular electrical power) and/or energy consumed by at least one of the drives of the device during a working process;

and the step of determining an energy efficiency for the respective working process and for the predetermined setpoint conveyor flow and/or for an instantaneous actual conveyor flow with the aid of the at least one value of the consumed power and/or energy, control data relating to the drive speed, in particular control data for a frequency converter, being provided for the at least one drive as a function of the (respective) energy efficiency.

According to one aspect, a computer program product is provided, comprising program code which, when it is executed on a computer device, causes the computer device to carry out the method as described above.

Further features and advantages will be clear to the person skilled in the art on studying the following detailed description and inspecting the appended drawings.

### BRIEF DESCRIPTION OF THE DRAWINGS

The parts shown in the figures are not necessarily true to scale; rather, the emphasis is on presenting the principles of the invention.

FIG. 1 schematically shows by way of example a view of a device for continuously conveying medium in a configuration as a conveyor belt device;

FIG. 2 schematically shows by way of example a control system of the device according to FIG. 1.

### DETAILED DESCRIPTION

In the following detailed description, reference is made to the appended drawing, in which the way that the invention may be implemented in practice is shown by illustrating specific embodiments.

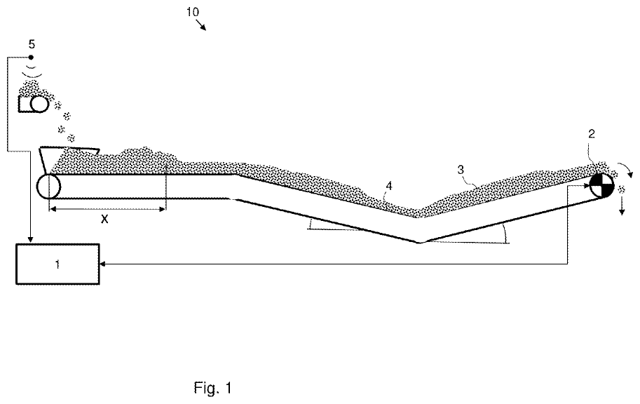

FIG. 1 shows a control system 1 which is coupled to, or is integrated in, a device 10 for continuously conveying material. The device 10 comprises one or more conveying drives 2 arranged successively in a material flow direction, which drive a conveyor belt 4 by means of which the material 3 is conveyed. A material throughput monitor 5 having at least one sensor (optionally having a plurality of measurement units at a plurality of measurement points) allows more in-depth analysis of the material throughput (instantaneous conveyor performance). For example, the material throughput monitor 5 comprises an occupancy sensor which is adapted to register a layer height of the material 3. The conveyor belt or belts 4 (conveyor belt segments) may also, for example, respectively have individual gradients or inclinations. An intermediate bunker may respectively also be provided at material transfer positions, in particular also between individual conveyor belts.

The conveyor belt 4 conveys an instantaneously moved material mass with an individual instantaneous belt speed. A rotational speed may in this case be specified to the at least one drive, in particular as a function of a respective individual instantaneous drive power. The technical control/regulation interaction is indicated by the arrows between the conveying components and the control system 1.

FIG. 1 also illustrates a smoothing function of intermediate bunkers at material transfer positions. In particular, the storage/buffer function of the respective intermediate bunker allows smooth variation of a downstream belt speed, in particular while taking into account the instantaneous bunker filling level, which may for example be registered by means of sensors 5.

Referring to FIG. 1, the following parameters may in particular also be described: instantaneous conveyor quantities at entry and exit transfer points; layer height and cross-sectional area for material flow (in particular registered by an occupancy sensor); section lengths of individual section segments with a constant inclination; instantaneously moved material masses on the respective section segments; instantaneous rotational drive speed and belt speed; instantaneous drive power; inclination of a respective section segment; layer height and length-referenced material flow mass of the bulk material at the longitudinal coordinate “x”; maximum allowed material flow height (particularly in order to avoid pileup).

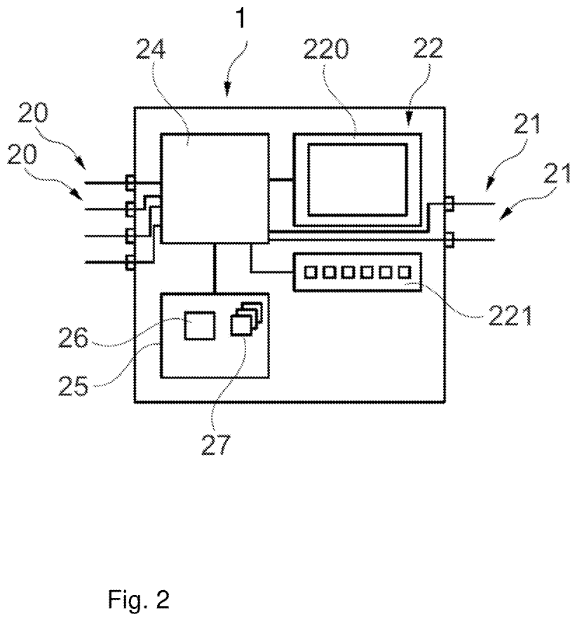

FIG. 2 shows the control system 1 of the device 10. The control system 1 comprises a plurality of inputs 20 and a plurality of outputs 21. At the inputs 20, the control system 1 is connected to a further control unit or one or more drives of the device 10, specifically in such a way that it can register at least one value of a power (in particular electrical power) consumed by at least one of the drives 12 during a working process. Optionally, the control system 1 may register values of the power consumed during a working process by a plurality, in particular all of the drives. The value or the values may indicate the power consumed overall during the entire working process. Optionally, the control system 1 is adapted to receive sensor data, which indicate a rate of advance and/or a conveyor performance (in particular a conveyed material volume and/or a conveyed material mass) through the inputs 20. As an alternative or in addition, the control system 1 may be adapted to receive sensor data, which for example indicate a current material composition (for example from at least one radar, ultrasound or laser sensor) and/or environmental data through the inputs 20.

The control system 1 comprises a computer unit 24, which obtains the value or the values of the consumed power. The control system 1 furthermore receives an indication of the amount of material, for example the material volume and/or the material weight, conveyed in the time period in which the consumed power was consumed. The indication specifies, for example, the material volume and/or the material weight which has been taken up by the bucket wheel 101 (or in general the working member) in the corresponding working process. The material may be weighed and/or measured. As an alternative or in addition, the weight and/or the volume may be estimated. The device 10, in particular the control system 1, may comprise one or more corresponding sensors, which may for example be arranged on the conveyor belt.

With the aid of the value or the values of the consumed power and the indication of the amount of material conveyed, the control system 1 determines an energy efficiency for the working process. For this purpose, the control system calculates (by means of the computer unit 24) an energy efficiency coefficient as the at least one value of the consumed power divided by the total volume or the total mass of the material taken up during the working process. The energy efficiency coefficient is optionally separate for individual segments along the conveyor section and/or individual drives. A series of energy efficiency coefficients may be determined for a part or for all of the procedure.

The control system 1 comprises a user interface 22 having a display device 220. The control system 1 displays the energy efficiency that has been determined, in particular the energy efficiency coefficient that has been calculated, by means of the display device 220. A user can read from this information how energy-efficient the settings selected in the associated working process were, and optionally may manually adapt settings accordingly.

The user interface 22 furthermore comprises an input means 221. Optionally a user may be able to make or adapt settings (for example material feed at transfer positions, drive speed and/or target feed rate), which the control system 1 then sets for a current working process and/or one or more subsequent working processes, via the input means 221. In order to make settings, the control system 1 is connected via the outputs 21 to a further control unit and/or to one or more drives. Via the outputs 21, the control system 1 then for example outputs corresponding control data.

In this way, it is possible to improve the energy efficiency of the device 10, for example in respect of a substantially unchanged conveyor rate.

The user interface 22 may for example comprise a display screen as a display device 220, and as input means 221 the display screen may be touch-sensitive, or as an alternative or in addition a keypad or the like may be provided. Furthermore, it is also possible to provide the user interface 22 by means of a web application, for example as a website.

Furthermore, the control system 1 comprises a memory 25 for storing computer-readable data. An optional optimization module 26 is stored in the memory 25. A plurality of variation parameters 27 are stored in the memory 25. The memory 25 allows ongoing storage and analysis of values. The memory 25 may be permanently installed or removable. The memory 25 is a computer program product.

The control system 1 runs the optimization module 26 by means of the computer unit 24. The optimization module 26 receives at least one variation parameter 27, for example in respect of at least one drive speed. The control system 1 varies the at least one variation parameter 27 over a plurality of working processes and/or over consecutive components. The optimization module 26 determines that value of the at least one variation parameter for which the highest energy efficiency has been determined, in particular for which the energy efficiency coefficient is minimized, as an optimized variation parameter. The optimization module 26 may evaluate the variation parameter after each cycle and/or optimize it iteratively over a plurality of working processes. Optionally, the optimization module 26 optimizes a plurality of variation parameters, for example successively.

For a current working process and/or one or more subsequent working processes, the control system 1 then makes settings according to the optimized variation parameter, for example by outputting corresponding control data through the outputs 21. Optionally, the optimization module 26 optimizes a variation parameter, for example a drive speed, and adjusts another parameter proportionally or inversely proportionally thereto. For example, the optimization module 26 (in general the control system 1) changes a drive speed proportionally to the change in the material feed at transfer positions. In this way, the desired conveyor rate may also be supervised.

More energy-efficient material transport may thus be achieved while complying with desired setpoint conveyor performances.

Optionally, the respective parameters or values are optimized for individual section segments and respectively from working process to working process.

In one optional configuration, the optimization module 26 optimizes a maximum conveyor rate, in particular the target conveyor rate, as a variation parameter. In some cases, a task is not time-critical, for example if more time is available for providing a predetermined material volume than is required with the maximum adjustable conveyor rate. Then, as an alternative or in addition to other variation parameters, the target conveyor rate may be optimized as a variation parameter.

Optionally, by using the input means 221 it is possible to adjust which adjustable parameter should be optimized as a variation parameter.

The control system 1 may be the central control system of the device 10. Alternatively, it is an additional control system 1 actively connected to one or more other control units of the device 10. Optionally, the control system 1 may be retrofitted to an existing conveyor belt device. Optionally, the control system 1 may be brought into communicative connection with an existing machine control and/or with sensors (and/or other control members, for example at least one frequency converter) by means of analog interfaces and/or a field bus system, for example by means of a conventional industrial communication interface.

The individual components of the control system 1, as are shown in FIG. 2, may be mounted on or in a common housing. As an alternative, some or all components are arranged at different locations (for example at different positions of the device 10) and are actively connected to one another.

By the adaptive energy-efficient regulation, a control method with stepwise variation of values or parameters in a defined sequence may therefore be provided for the continuously conveying device. This allows a stepwise approach of the specific energy demand (expressed in terms of the material volume conveyed) to a minimum possible value while maintaining a predetermined conveyor performance.

The device for continuously conveying material has been described above by way of example as a conveyor belt device or a conveyor belt system. Naturally, the indications above also apply correspondingly for other continuously working apparatuses.

The control system described above, a device equipped therewith, and the method allow and provide in particular one or more of the following operating modes.

The entire energy outlay for the material take-up, material conveying and material deposition may be minimized for a defined conveyor quantity.

An energy minimization (and cost minimization) for the transport of a predetermined amount of material is possible while specifying an allowed conveyor performance reduction or a maximum conveyor time for this amount.

Furthermore, automatic adaptation of material buffering, in particular at material transfer positions, to the varying material feed by upstream extraction apparatuses is possible with the aim of maintaining the conveyor performance efficiency and/or energy efficiency.

As used here, the terms “comprising”, “having”, “including”, and similar open terms which indicate the presence of elements or features mentioned, do not however exclude additional elements or features. It should be pointed out that the present invention is not restricted by the description given above, nor is it restricted by the appended drawings. Rather, the present invention is restricted only by the following claims and legal equivalents thereof.

### LIST OF REFERENCES

1 control system
2 drive
3 material
4 conveyor belt
5 material throughput monitor (sensor/measurement units)
10 device for continuously conveying material
20 input
21 output
22 user interface
220 display device
221 input means
24 computer unit
25 memory
26 optimization module
27 variation parameter
x longitudinal direction or conveyor direction

1.-16. (canceled)

17. A control system for a device for continuously conveying material that includes a conveyor belt and a conveyor belt device adapted to continuously convey the material, wherein the conveyor belt device is configured to be operated by way of a drive in working processes to provide a predeterminable setpoint conveyor flow, wherein the conveyor belt device includes an occupancy sensor, wherein the control system is configured to:
determine a length-referenced belt occupancy by integrating a conveyor belt speed with respect to time, wherein a material lifting power is given by a height profile and therefore by a height variation of a load;
determine an instantaneous lifting power as a sum-product of work due to gravity and a lifting speed of a respective section segment;
determine a cleaned total running power from a total drive power minus the material lifting power;
register a value of power and/or energy consumed by the drive during one of the working processes and to determine an energy efficiency for the respective working process and for the predeterminable setpoint conveyor flow and/or for an instantaneous actual conveyor flow with the aid of the value of power and/or energy consumed, wherein a ratio of the total running power to a momentum of the material that is moved permits quantitative evaluation of the energy efficiency for pure horizontal transport; and
provide control data relating to drive speed, including control data for a frequency converter, for the drive as a function of the energy efficiency.

18. The control system of claim 17 configured to calculate a ratio of total consumed energy of the drive within one of the working processes to the setpoint conveyor flow and/or to an instantaneous conveyor flow to determine the energy efficiency.

19. The control system of claim 17 configured to provide the device with control data regarding a subsequent working process as a function of the energy efficiency determined for the working process.

20. The control system of claim 19 configured to receive sensor data and calculate the control data as a function of the sensor data.

21. The control system of claim 17 wherein to determine the energy efficiency, the control system is configured to determine an energy efficiency coefficient as the value of the total energy consumed by the drive within one of the working processes divided by a total volume or a total mass of the material that is conveyed during the working process.

22. The control system of claim 21 wherein drive power consumed by the drive is used to determine the energy efficiency coefficient.

23. The control system of claim 17 configured to obtain an optimized variation parameter by which the energy efficiency is increased in comparison with other values of the optimized variation parameter, by varying at least one variation parameter over the working processes.

24. The control system of claim 23 wherein the drive comprises a first drive and a second drive, wherein each working process successively comprises an at least approximately constant conveyor movement by the first drive and at least one accelerating and/or decelerating drive actuation by the second drive, wherein the variation parameter comprises a value of a conveyor movement and/or a value of drive actuation.

25. The control system of claim 24 configured to provide the device with control data regarding a subsequent working process as a function of the energy efficiency determined for the working process, wherein the control data are based on an optimized value of conveyor movement and an optimized speed of the drive actuation, wherein the control system is configured to calculate the optimized speed of the drive actuation from the product of a predetermined speed of the drive actuation times a ratio of a predetermined value of the conveyor movement to the optimized value of the conveyor movement.

26. The control system of claim 23 wherein the variation parameter comprises a maximum conveyor rate.

27. The control system of claim 23 comprising a user interface for adjusting the variation parameter.

28. The control system of claim 17 configured to determine a total energy efficiency of the working processes.

29. A device for continuously conveying material, the device comprising a conveyor belt device adapted for continuously conveying the material and a conveyor belt, wherein the conveyor belt device is configured to be operated via a drive in working processes to provide a predeterminable setpoint conveyor flow with variable drive speeds, the device comprising the control system of claim 17.

30. The device of claim 29 configured as a conveyor belt system.

31. A method for controlling a device for continuously conveying material, the device comprising a conveyor belt device adapted to continuously convey the material, wherein the device comprising a conveyor belt, wherein the conveyor belt device is configured to be operated by a drive in working processes to provide a predeterminable setpoint conveyor flow, wherein the method comprises:
registering a value of power and/or energy consumed by the drive during one of the working processes;
determining a length-referenced belt occupancy by integrating a conveyor belt speed with respect to time;
determining a cleaned total running power from a total drive power minus a material lifting power, wherein the material lifting power is based on a height profile based on a height variation of a load, wherein an instantaneous lifting power is determined as a sum-product of work due to gravity and a lifting speed of a respective section segment;
determining an energy efficiency for the respective working process and for the predeterminable setpoint conveyor flow and/or for an instantaneous actual conveyor flow with the aid of the a value of the power and/or energy consumed, wherein a ratio of the total running power to a momentum of the material that is moved allows quantitative evaluation of the energy efficiency for pure horizontal transport; and
providing control data relating to a drive speed, including control data for a frequency converter, for the drive as a function of the energy efficiency.
